(19) United States
(12) Patent Application Publication
(10) Pub. No.: US 2013/0057797 A1
(43) Pub. Date: Mar. 7, 2013

(54) LIQUID CRYSTAL DISPLAY DEVICE

(71) Applicant: Takahiro NAGAMI, Mobara (JP)

(72) Inventor: Takahiro NAGAMI, Mobara (JP)

(73) Assignee: Japan Display East Inc.

(21) Appl. No.: 13/596,097

(22) Filed: Aug. 28, 2012

(30) Foreign Application Priority Data
Sep. 7, 2011 (JP) 2011-194552

(51) Int. Cl. G02F 1/1368; G02F 1/1343

(52) U.S. Cl. 349/46; 349/43

(57) ABSTRACT

In a liquid crystal display device including multiple pixels, each pixel includes a thin-film transistor (TFT) including source and drain electrodes and a gate electrode; and a pixel unit including a common electrode and a pixel electrode. The common electrode is disposed over an inorganic passivation film formed over the pixel electrode and the source and drain electrodes. The gate electrode overlaps a pixel electrode of an adjacent pixel, thereby constituting a holding capacitance.

### CLAIM OF PRIORITY

The present application claims priority from Japanese patent application JP 2011-194552 filed on Sep. 7, 2011, the content of which is hereby incorporated by reference into this application.

### BACKGROUND OF THE INVENTION

1. Field of the Invention

The present invention relates to an in-plane switching liquid crystal display device having excellent viewing angle characteristics.

2. Description of the Related Art

A liquid crystal display panel used in a liquid crystal display device includes a TFT substrate, a counter substrate disposed as opposed to the TFT substrate, and liquid crystal interposed between the TFT substrate and the counter substrate. The TFT substrate has pixels each including a pixel electrode, a thin-film transistor (TFT), and the like arranged in a matrix thereon. The counter substrate has color filters and the like disposed in positions corresponding to the pixel electrodes of the TFT substrate thereon. The liquid crystal display panel forms images by controlling the transmittance of light using liquid crystal molecules for each pixel.

Since liquid crystal display devices are flat and light-weight, their applications are expanding in a variety of fields. Small liquid crystal display devices are widely being used in mobile phones, digital still cameras (DSCs), and the like. However, liquid crystal display devices have a problem with viewing angle characteristics. Viewing angle characteristics refer to a phenomenon in which luminance or chromaticity when the screen is viewed obliquely is different from that when the screen is viewed from the front. In-plane switching (IPS) liquid crystal display devices, which drive liquid crystal molecules using a horizontal electric field (lateral electric field), have excellent viewing angle characteristics.

Among various types of IPS is a type in which a comb teeth-shaped pixel electrode or common electrode is disposed above a flat, solid common electrode or pixel electrode with an insulating film therebetween and in which liquid crystal molecules are rotated by an electric field generated between the pixel electrode and the common electrode. This type can increase transmittance and is currently going mainstream.

In a conventional IPS type as described above, TFTs are first formed and then covered by a passivation film, and the above-mentioned common electrode, insulating film, pixel electrode, and the like are formed over the passivation film. However, there is a requirement to reduce the manufacturing cost. For this reason, the number of layers such as the conductive layer, insulating layer, and the like in the TFT substrate has been reduced (for example, Japanese Patent Application No. 2010-217062 (Japanese Patent Application Laid-Open Publication No. 2012-73341)).

### SUMMARY OF THE INVENTION

In Japanese Patent Application Laid-Open Publication No. 2012-73341, TFTs and pixel electrodes are formed and then a passivation film and a common electrode are sequentially formed. This makes it possible to omit an insulating film which is conventionally disposed between the TFTs and the pixel electrodes, as well as to omit the step of processing the insulating film to form a contact hole for coupling the pixel electrodes with the TFTs. As a result, the manufacturing cost can be reduced. Further, since the passivation film is composed of only an inorganic film, the omission of the step of processing an organic film as well as an increase in transmittance can be accomplished compared with a case where it is a multilayer composed of an inorganic film and an organic film.

However, if no organic passivation film is disposed, it is necessary to form a thick inorganic passivation film to protect the wiring or circuit around the effective display area. In this case, the holding capacitance between the pixel electrode and the common electrode is reduced. There is a trend of small LCD cells for mobile phones to reduce power. Accordingly, when the signal level is reduced, the margin for a feed-through voltage (a coupling voltage drop) is reduced. As a result, even a level of a feed-through voltage that has not been a problem may cause flicker or the like.

For this reason, the inventors have contemplated reducing the thickness of the inorganic passivation film to increase the holding capacitance as well as increasing the margin for a feed-through voltage. However, the inventors have found that the thickness of the inorganic passivation film is difficult to reduce to less than the current thickness (500 nm) in terms of the protection of the wiring or circuit around the effective display area.

An advantage of the present invention is to provide a liquid crystal display device that can protect the wiring or circuit around the effective display area, as well as can control the effect of a feed-through voltage.

A liquid crystal display device according to an aspect of the present invention includes: a thin-film transistor (TFT) substrate, the TFT substrate including: a display area including multiple pixels; and an IC driver for displaying an image on the display area; a counter substrate disposed as opposed to the TFT substrate; and a liquid crystal layer interposed between the TFT substrate and the counter substrate. Each of the pixels includes a TFT and a pixel unit, the TFT including source and drain electrodes and a gate electrode, the pixel unit including a common electrode and a pixel electrode. The common electrode is disposed over an inorganic passivation film formed over the pixel electrode and the source and drain electrodes. The pixel electrode is directly coupled to one of the source and drain electrodes and has a portion which vertically overlaps a gate electrode of a TFT of an adjacent pixel, thereby constituting a holding capacitance.

According to the aspect of the present invention, the pixel electrode is directly coupled to one of the source and drain electrodes and has a portion that vertically overlaps a gate electrode of a TFT of an adjacent pixel, thereby constituting a holding capacitance. Thus, it is possible to provide a liquid crystal display device that can protect the wiring or circuit around the effective display area, as well as can control the effect of a feed-through voltage.

### BRIEF DESCRIPTION OF THE DRAWINGS

FIG. 1A is a plan view showing a manufacturing process (gate electrode formation) of a liquid crystal display device according to a first embodiment;

FIG. 1B is a plan view showing a manufacturing process (semiconductor layer formation) of the liquid crystal display device according to the first embodiment;

FIG. 1C is a plan view showing a manufacturing process (source and drain electrodes formation) of the liquid crystal display device according to the first embodiment;

FIG. 1D is a plan view showing a manufacturing process (pixel electrode formation) of the liquid crystal display device according to the first embodiment;

FIG. 1E is a plan view showing a manufacturing process (common electrode formation) of the liquid crystal display device according to the first embodiment;

FIG. 1F is a plan view showing a manufacturing process (black matrix-including counter substrate disposition) of the liquid crystal display device according to the first embodiment;

FIG. 2A is a plan view of a main part of the liquid crystal display device according to the first embodiment;

FIG. 2B is a sectional view taken along A-A′ of FIG. 2A;

FIG. 3A is a plan view showing a manufacturing process (gate electrode formation) of a liquid crystal display device contemplated by the inventors;

FIG. 3B is a plan view showing a manufacturing process (semiconductor layer formation) of the liquid crystal display device contemplated by the inventors;

FIG. 3C is a plan view showing a manufacturing process (source and drain electrodes formation) of the liquid crystal display device contemplated by the inventors;

FIG. 3D is a plan view showing a manufacturing process (pixel electrode formation) of the liquid crystal display device contemplated by the inventors;

FIG. 3E is a plan view showing a manufacturing process (common electrode formation) of the liquid crystal display device contemplated by the inventors;

FIG. 3F is a plan view showing a manufacturing process (black matrix-including counter substrate disposition) of the liquid crystal display device contemplated by the inventors;

FIG. 4A is a plan view of a main part of the liquid crystal display device contemplated by the inventors;

FIG. 4B is a sectional view taken along B-B′ of FIG. 4A;

FIG. 5A is a plan view showing a manufacturing process (gate electrode formation) of a liquid crystal display device according to a second embodiment;

FIG. 5B is a plan view showing a manufacturing process (semiconductor layer formation) of the liquid crystal display device according to the second embodiment;

FIG. 5C is a plan view showing a manufacturing process (source and drain electrodes formation) of the liquid crystal display device according to the second embodiment;

FIG. 5D is a plan view showing a manufacturing process (pixel electrode formation) of the liquid crystal display device according to the second embodiment;

FIG. 5E is a plan view showing a manufacturing process (common electrode formation) of the liquid crystal display device according to the second embodiment;

FIG. 5F is a plan view showing a manufacturing process (black matrix-including counter substrate disposition) of the liquid crystal display device according to the second embodiment;

FIG. 6 is a plan view of a main part of the liquid crystal display device according to the second embodiment; and

FIG. 7 is a plan view showing a schematic overall configuration of a liquid crystal display device according to the present invention.

### DESCRIPTION OF THE PREFERRED EMBODIMENTS

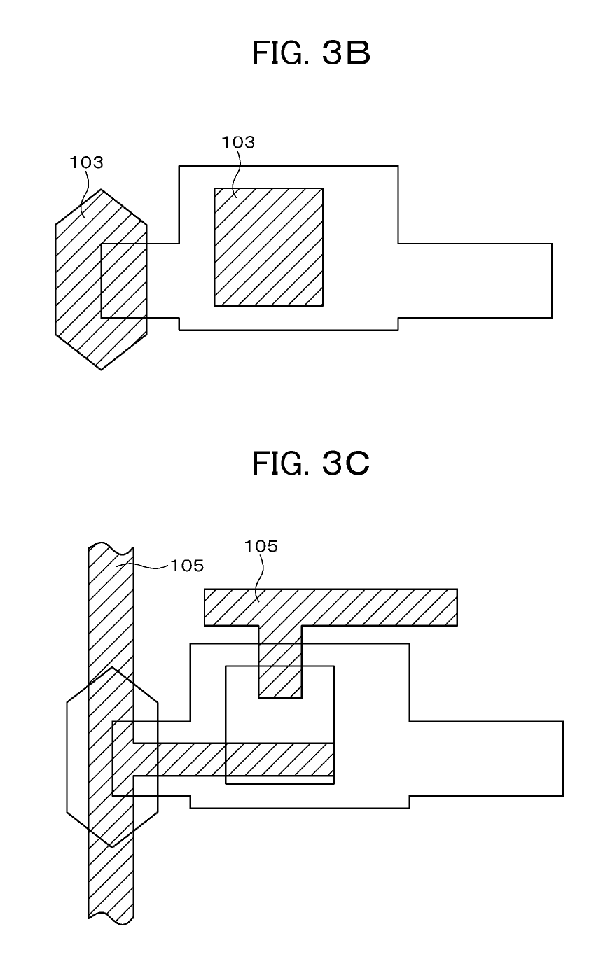

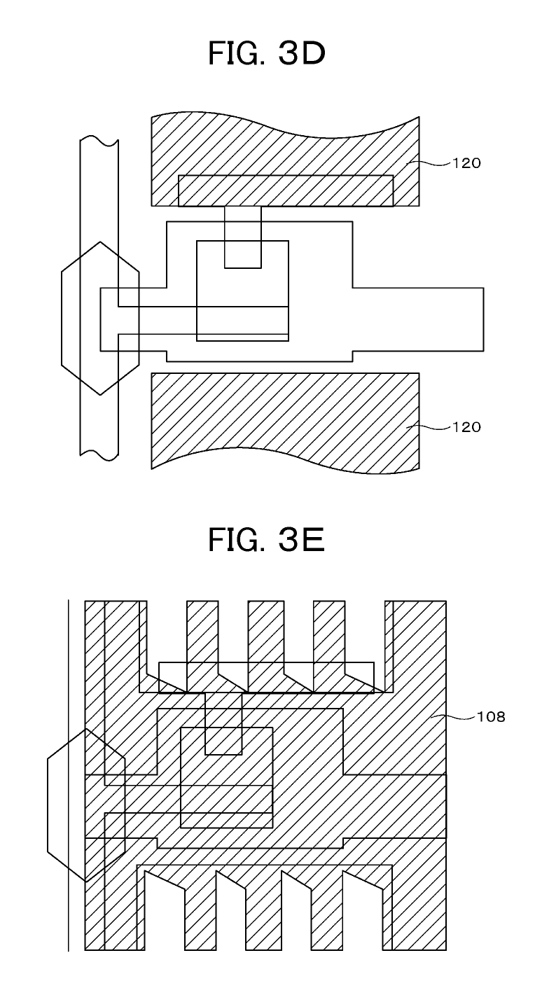

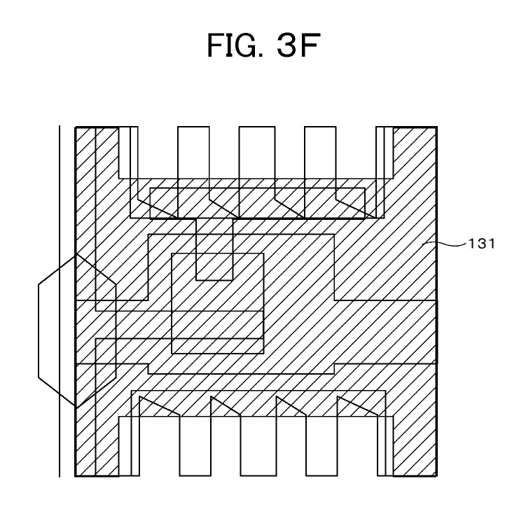

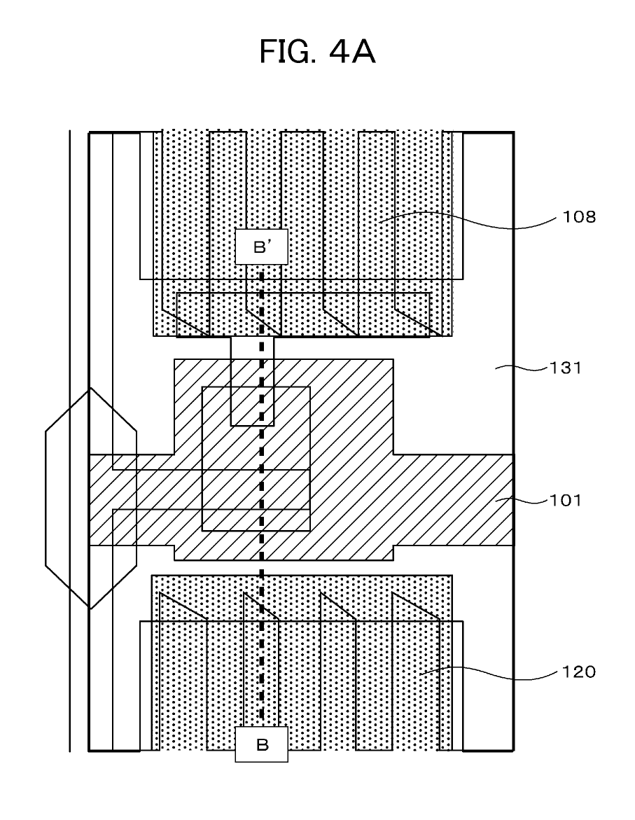

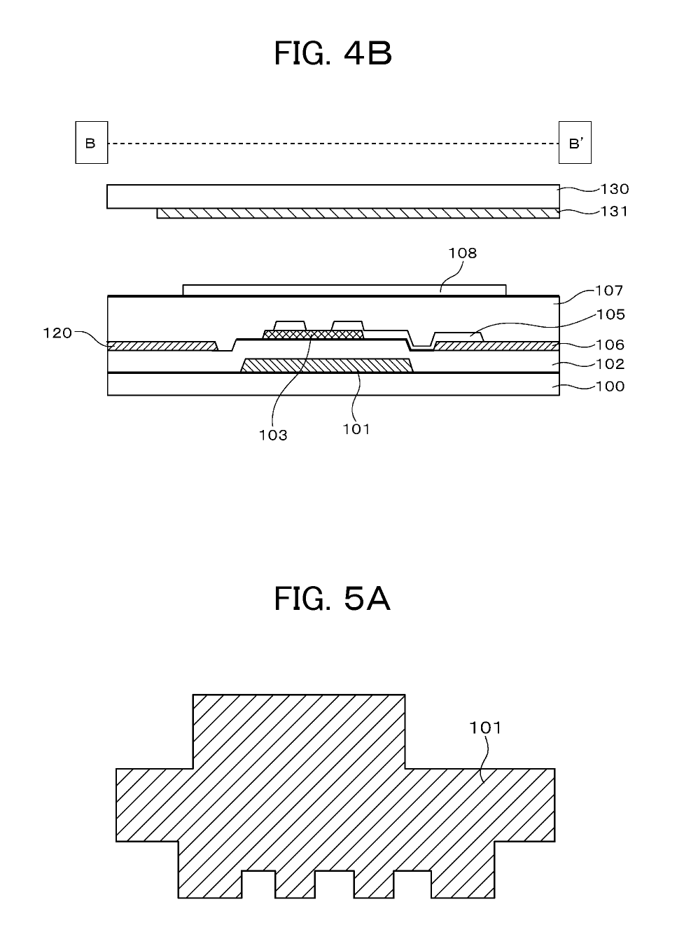

An increase in transmittance or a reduction in manufacturing cost is accomplished by sequentially forming an inorganic passivation film and a common electrode after forming TFTs and pixel electrodes. For this reason, the inventors have contemplated controlling the effect of a feed-through voltage (a coupling voltage drop) using this technology. Details of the contemplation will be described with reference to FIGS. 3A to 3F and FIGS. 4A and 4B. FIGS. 3A to 3F are plan views showing a manufacturing process of a liquid crystal display device contemplated by the inventors. FIG. 4A shows a plan view of the liquid crystal display device, and FIG. 4B shows a sectional view taken along BB′ of the liquid crystal display device shown in FIG. 4A.

First, the manufacturing process will be described. FIG. 3A shows a state in which a gate electrode 101 having a desired shape is formed over a TFT substrate 100. Subsequently, a gate insulating film 102 is formed over the gate electrode 101 and then a semiconductor layer 103 is formed over the gate electrode 101 (FIGS. 3B, 4B).

Subsequently, source and drain electrodes 105 are formed over the semiconductor layer 103 (FIG. 3C). The semiconductor layer between the source electrode and the drain electrode serves as a channel layer of a TFT. Subsequently, a pixel electrode 120 is formed (FIG. 3D). The pixel electrode 120 overlaps the source electrode 105 so as to make an electrical contact therebetween. In FIG. 4B, a pixel electrode 106 (120) is formed and then the source and drain electrode 105 are formed. However, these elements may be formed in any order. Note that the pixel electrodes 106 and 120 are simultaneously formed in FIG. 4B.

Subsequently, an inorganic passivation film 107 is formed so as to cover the source and drain electrodes 105 and the pixel electrode 120 (106), and a comb teeth-shaped common electrode 108 is formed over the inorganic passivation film 107 (FIGS. 3E, 4B). Subsequently, a counter substrate 130 including a black matrix 131 is disposed so as to be aligned with the TFT substrate (FIGS. 3F, 4A, 4B).

To increase the holding capacitance in a liquid crystal display device manufactured through these steps, it is effective to reduce the thickness of the inorganic passivation film. However, the inventors have found that it is difficult to reduce the thickness of the inorganic passivation film to less than the current thickness (500 nm) in terms of the need to protect the wiring or circuit around the effective display area against external contamination. For this reason, the inventors have contemplated increasing the capacitance using another element. Subsequently, the inventors have found that the pixel electrode 120 and the gate electrode 101 can be used, that is, the capacitance can be increased by overlapping the pixel electrode 120 (the pixel electrode in the n-th stage) and the gate electrode 101 (the electrode in the (n−1)th stage), which are away from each other in FIGS. 3D, 4A, and 4B. The present invention has been made based on this finding.

Hereafter, the present invention will be described in detail using embodiments.

### First Embodiment

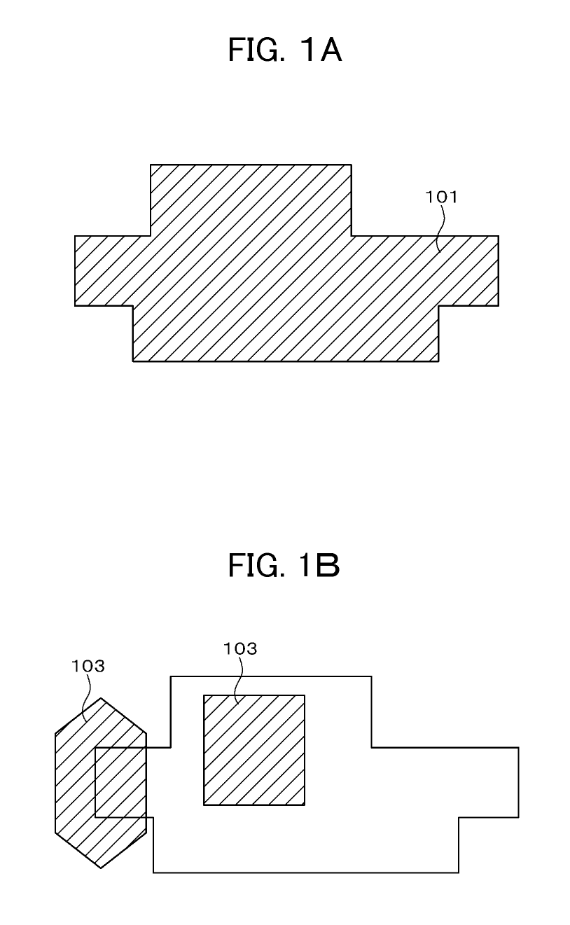

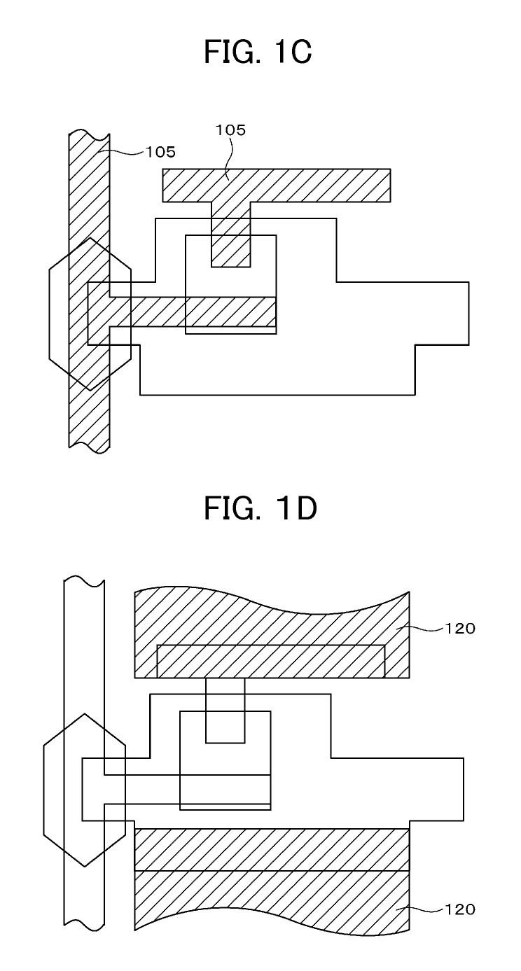

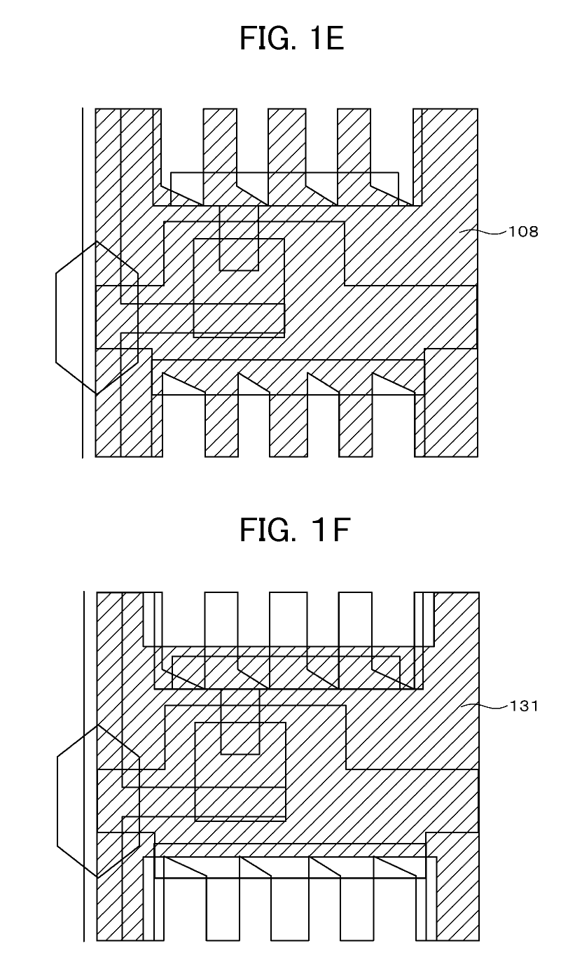

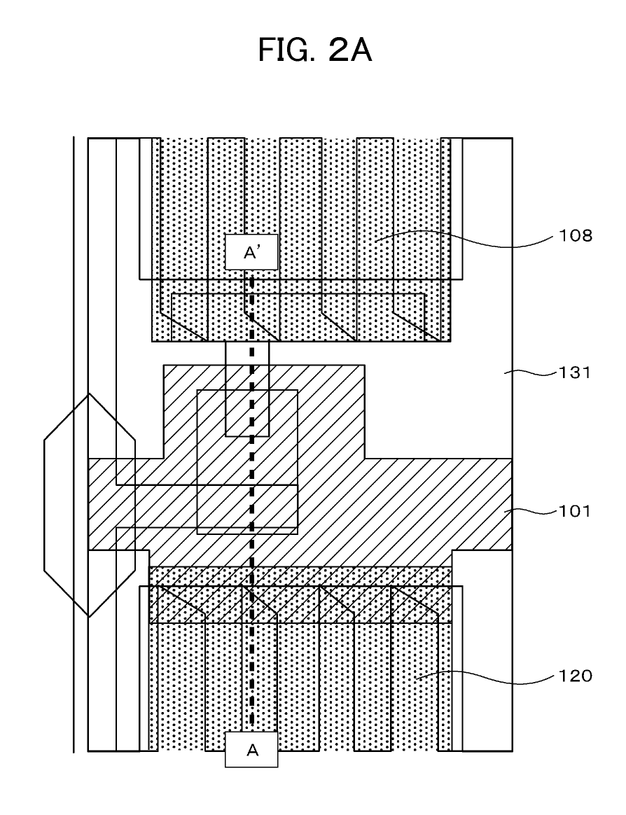

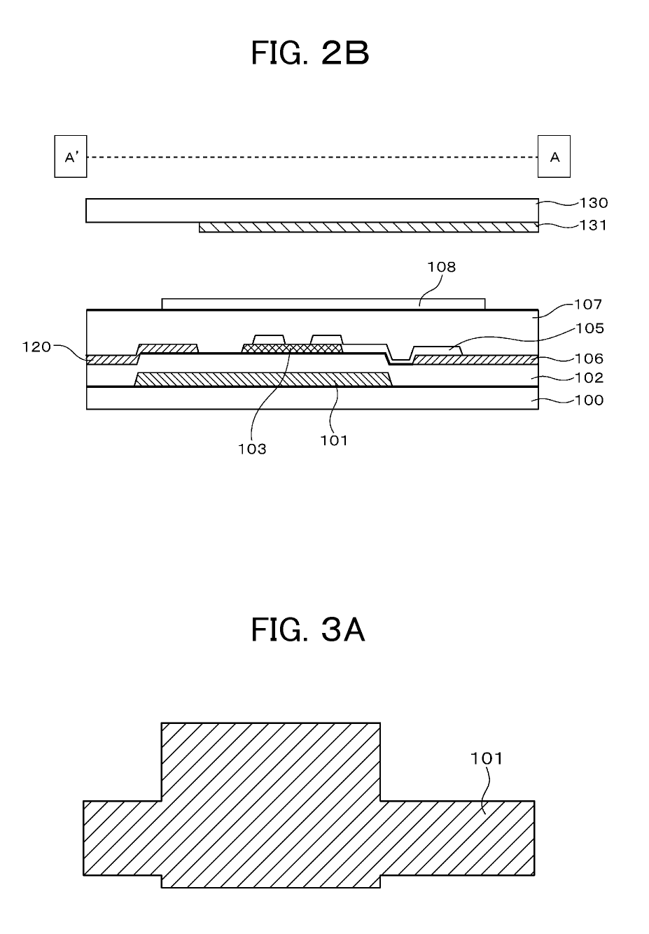

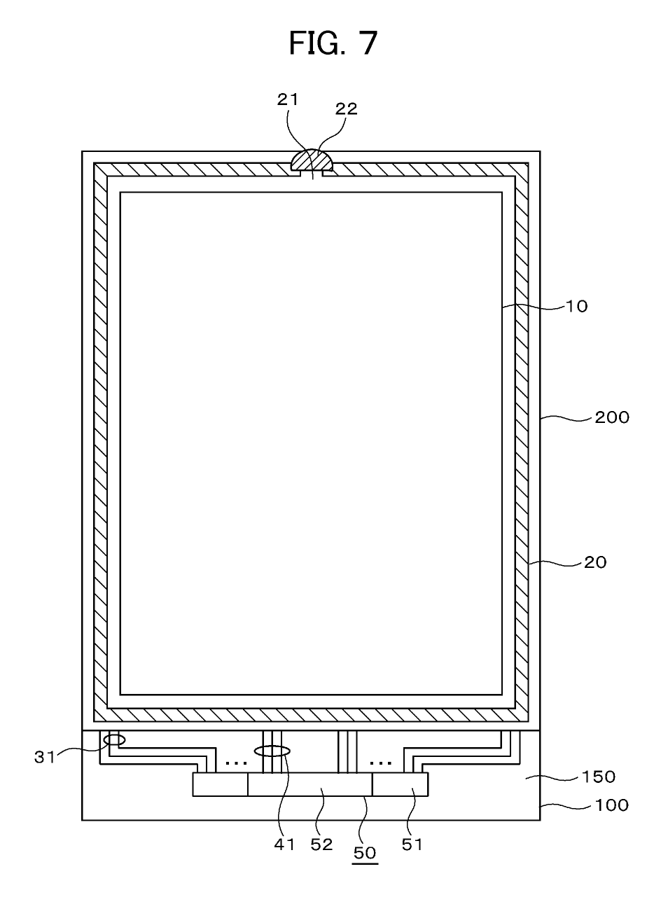

A first embodiment will be described with reference to FIGS. 1A to 1F, 2A, 2B, and 7. FIGS. 1A to 1F are plan views showing a manufacturing process of a liquid crystal display device according to this embodiment. FIG. 2A shows a plan view of the liquid crystal display device, and FIG. 2B shows a sectional view taken along AA′ of the liquid crystal display device shown in FIG. 2A. FIG. 7 is a plan view showing a schematic overall configuration of the liquid crystal display device according to this embodiment.

First, the overall configuration of the liquid crystal display device will be described with reference to FIG. 7. In FIG. 7, a counter substrate 200 is disposed over the TFT substrate 100. A liquid crystal layer is interposed between the TFT substrate 100 and the counter substrate 200. The TFT substrate 100 and the counter substrate 200 are bonded together by a sealant 20 formed over a frame.

A portion of an edge which is opposite to an edge 150 of FIG. 7 and over which no sealant is formed serves as an injection hole 21 for liquid crystal. Liquid crystal is injected through this portion. After injecting the liquid crystal, the injection hole 21 is sealed by a sealing material 22. The TFT substrate 100 is formed so as to be larger than the counter substrate 200. The edge 150 for providing power, video signals, scan signals, and the like is formed in the portion representing the difference in size between the TFT substrate 100 and the counter substrate 200.

Disposed on the edge 150 is an IC driver 50 for driving scan lines, video signal lines, and the like. The IC driver 50 includes three areas: a video signal drive circuit 52, which is disposed in the center; and scan signal drive circuits 51, which are disposed on both sides.

In a display area 10 of FIG. 7, scan lines (not shown) extend in the horizontal direction and are arranged in the vertical direction. Video signal lines (not shown) extend in the vertical direction and are arranged in the horizontal direction. The scan lines are coupled to the scan signal drive circuits 51 of the IC driver 50 via scan line leader lines 31. In FIG. 7, the scan line leader lines 31 are disposed on both sides of the display area 10 in order to dispose the display area 10 in the center of the liquid crystal display device. Accordingly, the scan signal drive circuits 51 are disposed on both sides of the IC driver 50. On the other hand, video signal leader lines 41 for coupling the video signal lines and the IC driver 50 are gathered below the screen. The video signal leader lines 41 are coupled to the video signal drive circuit 52 disposed in the center of the IC driver 50.

Next, the manufacturing process will be described. FIG. 1A shows a state in which the gate electrode 101 having a desired shape is formed over the TFT substrate 100 which is made of glass. The gate electrode is formed, for example, by layering MoCr over an AINd alloy. Subsequently, the gate insulating film 102 is formed over the gate electrode 101 and then the semiconductor layer 103 is formed over the gate electrode 101 (FIGS. 1B, 2B). The gate insulating film 102 is formed by sputtering SiN. The semiconductor layer 103 is formed by forming an a-Si film by CVD.

Subsequently, the source and drain electrodes 105 are formed over the semiconductor layer 103 in such a manner that the source and drain electrodes are opposed to each other (FIG. 10). The source and drain electrodes 105 are simultaneously formed of MoCr. The semiconductor layer between the source electrode and the drain electrode serves as a channel layer of a TFT. An n⁺Si layer (not shown) is formed in order to make an ohmic contact between the semiconductor layer 103 and one of the source and drain electrodes 105.

Subsequently, the pixel electrode 120 is formed of ITO so as to overlap the gate electrode 101 (FIG. 1D). To overlap the pixel electrode 120 and the gate electrode 101, any one of the pixel electrode and the gate electrode may be increased in size. In this embodiment, the gate electrode is formed so as to be increased in size. An amount of overlap of more than 0 between the gate electrode and the pixel electrode represents a capacitance increase effect. The capacitance increase effect increases as this amount increases. However, the transmittance decreases as the overlap amount increases. Accordingly, it is preferred to determine the amount of overlap between the gate electrode and the pixel electrode in consideration of the capacitance and transmittance. The pixel electrode also overlaps the source electrode 105 so as to make an electrical contact therebetween. In FIG. 2B, the pixel electrode 106 (120) is first formed and then the source and the drain electrodes 105 are formed. However, these elements may be formed in any order. Note that the pixel electrodes 106 and 120 are simultaneously formed in FIG. 2B.

Subsequently, the inorganic passivation film 107 is formed of SiN by CVD so as to cover the source and drain electrodes 105 and the pixel electrode 120 (106). The comb teeth-shaped common electrode 108 is formed over the inorganic passivation film 107 (FIGS. 1E, 2B). While the inorganic passivation film 107 is originally formed in order to protect the TFT, it also serves as an insulating film between the common electrode 108 and the pixel electrode 120 (106).

Subsequently, the counter substrate 130 including the black matrix 131 is disposed so as to be aligned with the TFT substrate (FIGS. 1F, 2A, 2B). The liquid crystal layer is interposed between the TFT substrate 100 and the counter substrate 130.

In the liquid crystal display device manufactured through the above-mentioned steps, the gate electrode 101 and the pixel electrode 120, which do not overlap each other in FIG. 4A, overlap each other. This makes it possible to increase the holding capacitance, reducing the effect of a feed-through voltage. The manufacturing process according to this embodiment only requires a change in the size of a mask for forming a gate electrode or pixel electrode. Accordingly, an increase in transmittance or a reduction in manufacturing cost can be accomplished without having to change the above-mentioned manufacturing process (FIGS. 3A to 3F) contemplated by the inventors. Further, an increase in the size of the gate electrode to increase the holding capacitance eliminates the need to form a black matrix for blocking domains in the roots of the comb teeth of the common electrode. The domains are portions from which when liquid crystal alignment is disturbed, light is leaked. The reason is that the gate electrode can be disposed in these domains and thus can also serve as a black matrix. When the domains are blocked by the black matrix disposed on the counter substrate, the accuracy of alignment between the TFT substrate and the counter substrate becomes 3 to 5.5 μm owing to the long distance between the substrates. This method is disadvantageous in increasing the accuracy. On the other hand, blocking the domains on the TFT substrate increases the alignment accuracy to 1.2 to 1.8 μm. Thus, the margin for alignment between the TFT substrate and the counter substrate can be increased. This can also apply to a case in which the pixel pitch is reduced (finer resolution). Further, the gate electrode disposed adjacent to the domains is increased in size in order to overlap the gate electrode and the pixel electrode. Thus, the domains can be blocked using a smaller area than that when a black matrix is disposed in portions corresponding to the domains on the distant counter substrate. As a result, contrast can be improved efficiently.

As described above, according to this embodiment, it is possible to provide a liquid crystal display device that can protect the wiring or circuit around the effective display area, as well as can control the effect of a feed-through voltage. Further, the gate electrode is increased in size in order to overlap the gate electrode and the pixel electrode. This eliminates the need to dispose a black matrix over the counter substrate, which can improve contrast. Furthermore, the margin for alignment between the TFT substrate and the counter substrate can be increased.

### Second Embodiment

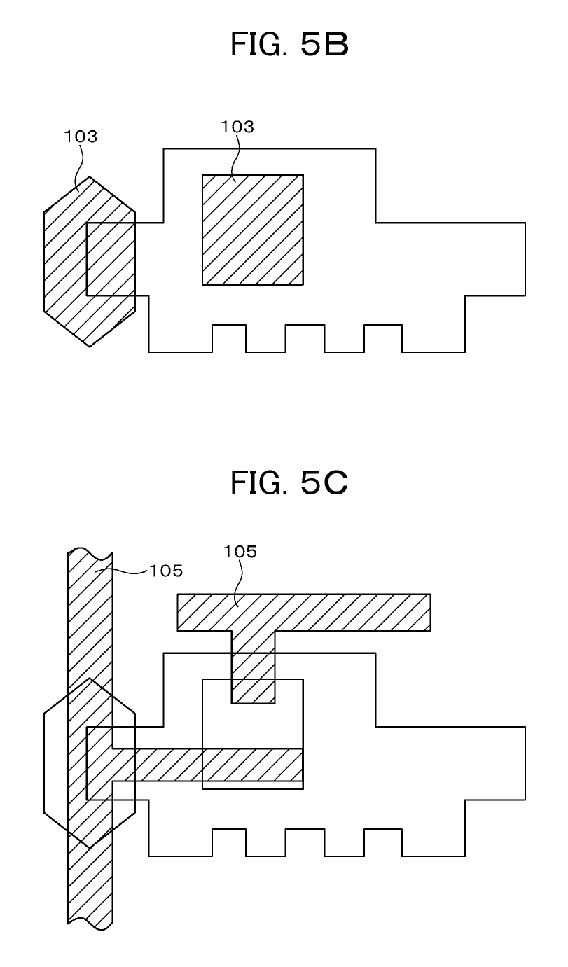

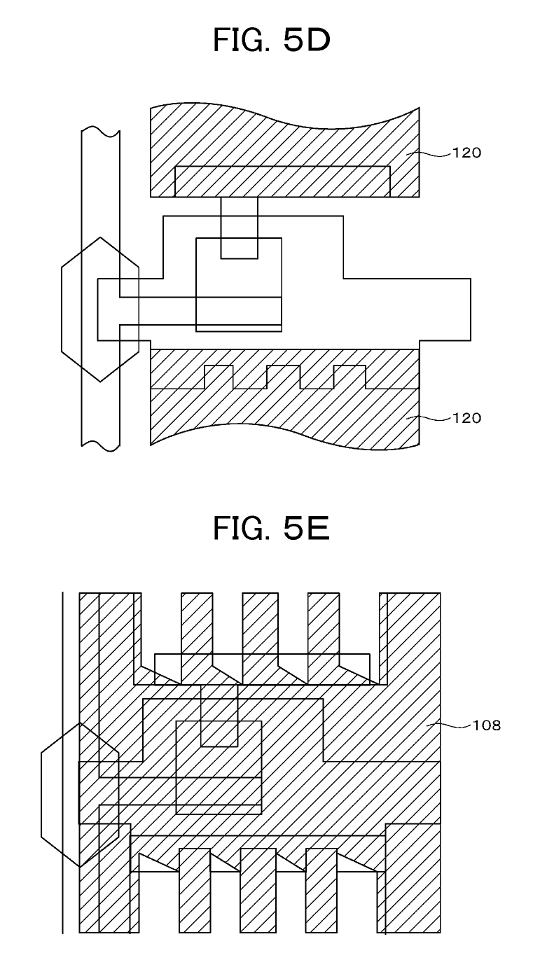

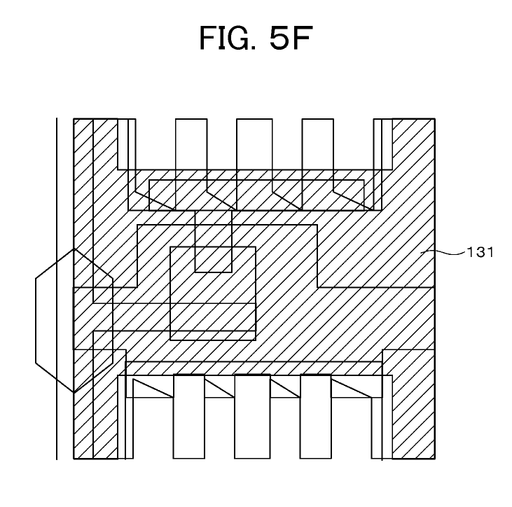

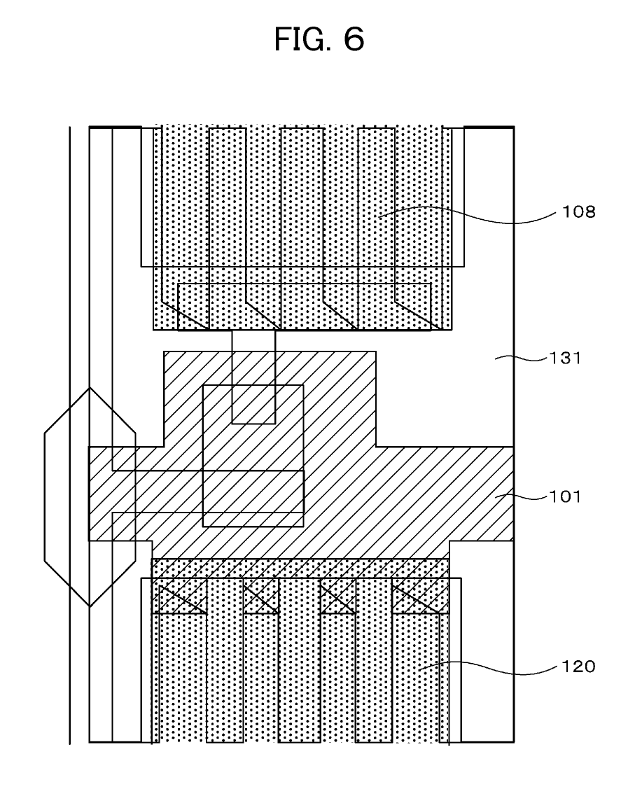

A second embodiment will be described with reference to FIGS. 5A to 5F and 6. FIGS. 5A to 5F are plan views showing a manufacturing process of a liquid crystal display device according to this embodiment. FIG. 6 shows a plan view of the liquid crystal display device. The matters that are described in the first embodiment but not described in this embodiment can apply to this embodiment.

The manufacturing process of the liquid crystal display device according to this embodiment will be described. FIGS. 5A to 5F are the same as FIGS. 1A to 1F according to the first embodiment and therefore will not be described in detail. FIG. 5A shows a state in which the gate electrode 101 is formed over the TFT substrate 100. In this embodiment, the bottom edge of the gate electrode is in the shape of bumps and dips. Subsequently, the gate insulating film 102 is formed over the gate electrode 101 and then the semiconductor layer 103 is formed over the gate electrode 101 (FIG. 5B).

Subsequently, the source and drain electrodes 105 are formed over the semiconductor layer 103 in such a manner that the source and drain electrodes are opposed to each other (FIG. 5C). Subsequently, the pixel electrode 120 is formed so as to overlap the area including the bumps and dips of the bottom edge of the gate electrode 101 (FIG. 5D). The pixel electrode 120 also overlaps the source electrode 105 so as to make an electrical contact therebetween.

Subsequently, the inorganic passivation film 107 is formed so as to cover the source and drain electrodes 105 and the pixel electrode 120. The comb teeth-shaped common electrode 108 is formed over the inorganic passivation film 107 (FIG. 5E). In this case, the common electrode 108 is disposed in such a manner that the bumps of the bottom edge of the gate electrode 101 overlap domains of the bottom of the common electrode 108. Thus, the domains can be blocked by the bumps of the bottom edge of the gate electrode. As for the dips of the bottom edge of the gate electrode, the common electrode is formed thereover. Since the material of the common electrode is ITO, the common electrode transmits light. As a result, a reduction in transmittance can be controlled.

Subsequently, the counter substrate 130 including the black matrix 131 is disposed so as to be aligned with the TFT substrate (FIGS. 5F and 6). The liquid crystal layer is interposed between the TFT substrate 100 and the counter substrate 130.

In the liquid crystal display device manufactured through the above-mentioned steps, the gate electrode 101 and the pixel electrode 120, which do not overlap each other in FIG. 4A, overlap each other. This makes it possible to increase the holding capacitance, reducing the effect of a feed-through voltage. The manufacturing process according to this embodiment only requires a change in the size of a mask for forming a gate electrode or pixel electrode. Thus, an increase in transmittance or reduction in manufacturing cost can be accomplished without having to change the above-mentioned manufacturing process (FIGS. 3A to 3F) contemplated by the inventors. Further, an increase in the size of the gate electrode to increase the holding capacitance eliminates the need to form a form a black matrix for blocking domains in the roots of the comb teeth of the common electrode. The domains are portions from which when liquid crystal alignment is disturbed, light is leaked. The reason is that the gate electrode can be disposed in these domains and thus can also serve as a black matrix. When the domains are blocked by the black matrix disposed on the counter substrate, the accuracy of alignment between the TFT substrate and the counter substrate becomes 3 to 5.5 μm owing to the long distance between the substrates. This is disadvantageous in increasing the accuracy. On the other hand, blocking the domains on the TFT substrate increases the alignment accuracy to 1.2 to 1.8 μm. Thus, the margin for alignment between the TFT substrate and the counter substrate can be increased. This can also apply to a case in which the pixel pitch is reduced (finer resolution). Further, the gate electrode disposed adjacent to the domains are increased in size in order to overlap the gate electrode and the pixel electrode. Thus, the domains can be blocked by a smaller area than that when a black matrix is disposed in portions corresponding to the domains on the distant counter substrate. As a result, contrast can be improved efficiently.

As described above, according to this embodiment, the same advantages as the first embodiment can be obtained. Further, forming the bottom edge of the gate electrode in the shape of bumps and dips can accomplish an increase in contrast while controlling a reduction in transmittance.

The present invention is not limited to the above-mentioned embodiments and includes various modifications thereto. While the embodiments have been described in detail to clarify the present invention, the invention is not to be construed as always including all the described components. Some components of each embodiment may be deleted or replaced with other components, or other components may be added.

What is claimed is:

1. A liquid crystal display device comprising:
a thin-film transistor (TFT) substrate, the TFT substrate including:
a display area comprising a plurality of pixels; and
an IC driver for displaying an image on the display area;
a counter substrate disposed as opposed to the TFT substrate; and
a liquid crystal layer interposed between the TFT substrate and the counter substrate, wherein
each of the pixels comprises a TFT and a pixel unit, the TFT comprising source and drain electrodes and a gate electrode, the pixel unit comprising a common electrode and a pixel electrode,
the common electrode is disposed over an inorganic passivation film formed over the pixel electrode and the source and drain electrodes, and
the pixel electrode is directly coupled to one of the source and drain electrodes and has a portion which vertically overlaps a gate electrode of a TFT of an adjacent pixel, thereby constituting a holding capacitance.

2. The liquid crystal display device according to claim 1, wherein the common electrode has a shape of comb teeth, and
the gate electrode is disposed so as to extend to domains in roots of the comb teeth of the common electrode, the domains being portions from which when liquid crystal alignment of the liquid crystal layer is disturbed, light is leaked.

3. The liquid crystal display device according to claim 2, wherein
the portion of the gate electrode that overlaps the pixel electrode is in the shape of bumps and dips in plan view, and
the bumps correspond to the positions of the domains.

4. The liquid crystal display device according to claim 1, wherein
the pixel electrode is formed below one of the source and drain electrodes.

5. The liquid crystal display device according to claim 1, wherein
the pixel electrode is formed above one of the source and drain electrodes.

6. The liquid crystal display device according to claim 2, wherein
portions of the counter substrate are translucent, the portions being opposed to the domains.
